(19) United States
(12) Patent Application Publication
(10) Pub. No.: US 2018/0014563 A1
(43) Pub. Date: Jan. 18, 2018

(54) Method and System for Making Protein Loaf, and Protein Loaf

(71) Applicants: Benjamin Todd Pasternak, Maidens, VA (US); Scott R. VanDevanter, Centerville, OH (US); Mark Edward Auernheimer, Richmond, VA (US); Richard John Matulis, Loveland, OH (US)

(72) Inventors: Benjamin Todd Pasternak, Maidens, VA (US); Scott R. VanDevanter, Centerville, OH (US); Mark Edward Auernheimer, Richmond, VA (US); Richard John Matulis, Loveland, OH (US)

(73) Assignee: Sugar Creek Packing Co., Hamilton, OH (US)

(21) Appl. No.: 15/210,377

(22) Filed: Jul. 14, 2016

(51) Int. Cl. B65D 81/34; A47J 27/10; B65D 81/20

(52) U.S. Cl. CPC A23L 13/57; B65D 81/3415; B65D 81/2007; A47J 27/10; A23L 13/428; A23L 13/48; A23L 5/13; A23P 30/10; A23P 20/12; A23V 2002/00

(57) ABSTRACT

A method for making a protein loaf, which may take the form of whole-muscle poultry, beef, pork, or veal, may include coating at least a portion of at least one of two pieces of protein with a bonding enzyme preparation along a bonding surface of one of the pieces; nesting the two pieces of protein in a mold and orienting the pieces such the coated bonding surface contacts a bonding surface of the other of the two pieces of protein; evacuating and sealing the pieces in a package such that the pieces are urged together along the bonding surfaces thereof and conform to the mold to form a loaf shape; and holding the pieces in the sealed package a time interval sufficient to allow the bonding enzyme preparation to cause cross-linking to occur between the bonding surfaces to form a unitary protein loaf from the two pieces of protein.

### TECHNICAL FIELD

This disclosure relates to food product preparation and, more particularly, methods and systems for making a protein loaf product from pieces of protein.

### BACKGROUND

Pre-cooked protein is a popular food product because it can be mass produced, infused with a variety of different flavorings, and kept for long periods of time without spoilage. Because of these attributes, pre-cooked protein is popular not only for domestic use, in which case it is purchased at supermarkets and other retail outlets, but commercially, such as in restaurants, especially fast-food restaurants, where it can be prepared for consumption quickly. Pre-cooked protein may take the form of chicken, which is most common, but also may take the form of pork, beef, and veal.

It is desirable to prepare such protein food products in log or loaf form because such forms are regularly shaped and facilitate packaging, shipping, and storage, as compared to protein products that are not in loaf form, such as whole chickens, whole chicken pieces, and various whole-muscle cuts of beef, pork, and veal. In order to make logs or loaves of such protein, it is necessary to grind or shred the protein in order to make the protein sufficiently formable to shape into the desired loaf or log. A loaf or log of protein product generally is in the shape of a rectangular cuboid, which facilitates packaging and storage.

A disadvantage with forming protein logs or loaves by shredding the protein product is that the texture, taste, and feel of the resultant log or loaf is less desirable than the comparable whole-muscle cut of protein. Accordingly, there is a need for a method and system for making a protein loaf, and protein loaf product, that shapes the desired protein into a loaf or log shape, but retains the whole muscle cut to provide natural texture, taste, and feel.

### SUMMARY

The present disclosure is a method and system for making protein loaf, and a protein loaf, that forms a loaf from whole-muscle cuts that provide a natural texture, taste, and feel. In one embodiment, a method for making a protein loaf includes coating at least a portion of at least one of two pieces of protein with a bonding enzyme preparation along a bonding surface of the at least one of two pieces of protein; nesting the two pieces of protein in a mold and orienting the two pieces of protein such the coated bonding surface of the at least one of the two pieces of protein contacts a bonding surface of the other of the two pieces of protein; evacuating and sealing the two pieces of protein in a package such that the two pieces of protein are urged together along the bonding surfaces thereof and conform to the mold to form a loaf shape; and holding the pieces of protein in the sealed package a time interval sufficient to allow the bonding enzyme preparation to cause cross-linking to occur between the bonding surfaces to form a unitary protein loaf from the two pieces of protein.

In another embodiment, a method for making a chicken loaf includes coating at least a portion of at least one of two skinless, boneless, whole-muscle, intact chicken breasts with a bonding enzyme preparation along a bonding surface of the at least one of two chicken breasts; nesting the two chicken breasts in a mold and orienting the two chicken breasts such that the breasts are inverted relative to each other, and such that the coated bonding surface of the at least one of the chicken breasts contacts a bonding surface of the other of the two chicken breasts; evacuating and sealing the two arranged chicken breasts in a package such that the two arranged breasts are urged together along the bonding surfaces thereof and conform to the mold to form a loaf shape; and holding the two arranged chicken breasts in the sealed package a time interval sufficient to allow the bonding enzyme preparation to cause cross-linking to occur between the bonding surfaces to form a unitary chicken loaf from the two chicken breasts.

In yet another embodiment, a poultry loaf includes a pair of intact poultry breasts that are inverted relative to each other, are thermoformed to a predetermined loaf shape, and are bonded together along mutually contacting surfaces by an enzyme preparation to form a single, unitary loaf; and are sous vide cooked.

In still another embodiment, a system for making a cooked protein loaf includes a dry depositor for depositing a bonding enzyme preparation on pieces of uncooked protein; a mold having a cavity in a predetermined protein loaf shape for receiving the pieces of uncooked protein with the bonding enzyme preparation applied thereto from the dry depositor; a thermoformer for receiving the mold and forming vacuum packages containing the uncooked protein with the bonding enzyme preparation applied thereto; a holding area for receiving vacuum packages of uncooked protein from the thermoformer and holding the vacuum packages for a time period sufficient to allow the enzyme preparation to bond the pieces of uncooked protein into a unitary loaf; and a hot water cooker for receiving the vacuum packages from the holding area and sous vide cooking the unitary loaf to make a cooked protein loaf.

Other objects and advantages of the disclosed method and system for making a protein loaf, and protein loaf product, will be apparent from the following description, the accompanying drawings, and the appended claims.

### BRIEF DESCRIPTION OF THE DRAWINGS

FIG. 1 is a schematic representation of the disclosed system for making a protein loaf;

FIG. 2 is a detail plan view of a mold and portion of a mold tray receiving two pieces of protein in the form of skinless, boneless, whole-muscle chicken breasts;

FIG. 3 is a detail plan view of the mold of FIG. 2 in which the chicken breasts are bonded to form a chicken loaf within a mold;

FIG. 4 is a perspective view of a package containing a fully cooked unitary, loaf-shaped chicken product from the chicken breasts of FIG. 2;

FIG. 5 is a flow chart showing the method for making a protein loaf; and

FIG. 6 is a perspective view of the mold of FIG. 2.

### DETAILED DESCRIPTION

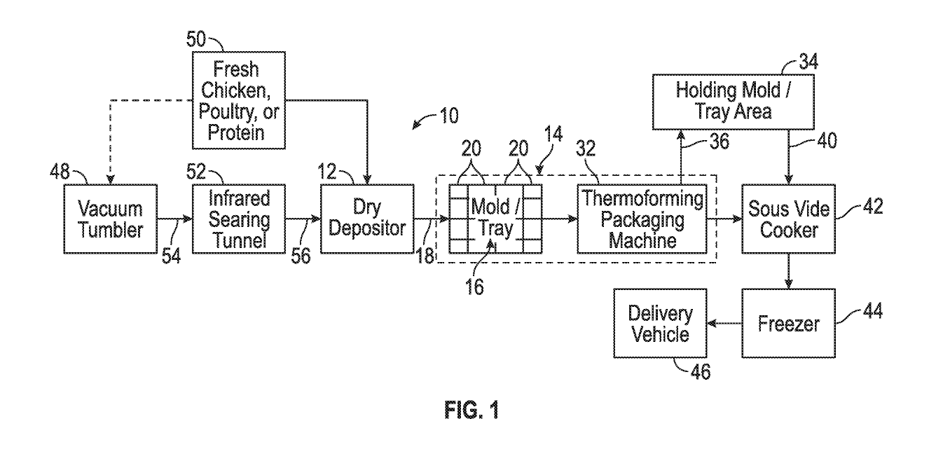

As shown in FIG. 1, the system for making protein loaf, generally designated 10, may include a dry depositor 12 that deposits a bonding enzyme preparation on pieces of uncooked protein. In an embodiment, the dry depositor is a shifting automatic dry ingredient depositor manufactured by Hinds-Bock Corporation, Bothell, Wash. The bonding enzyme preparation contained in the dry depositor may be a cross-linking enzyme preparation, such as Activa GS, manufactured by Ajinomoto North America, Inc. of Itasca, Ill.

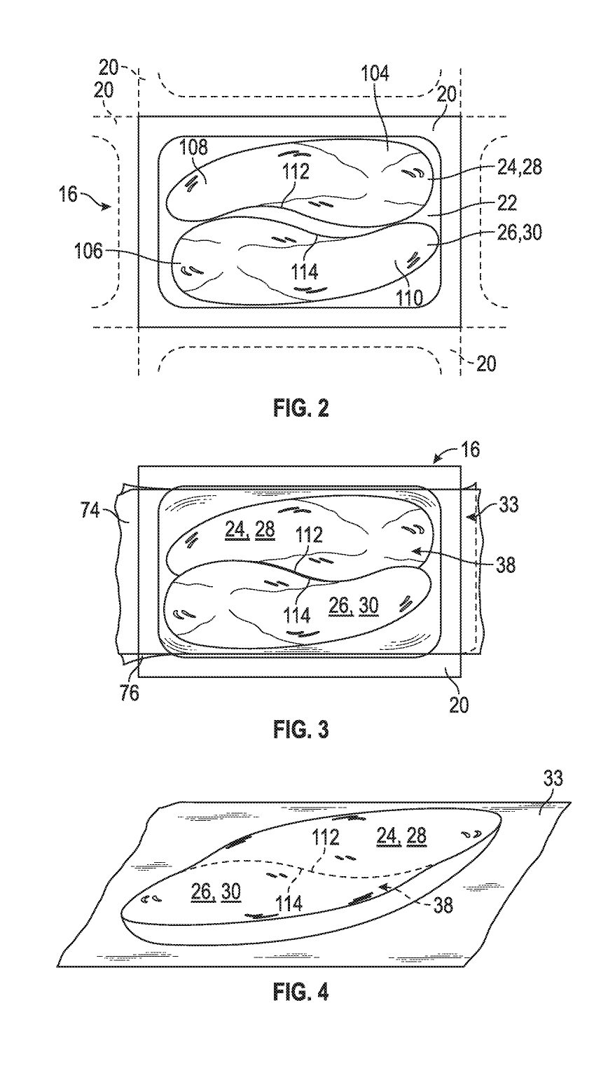

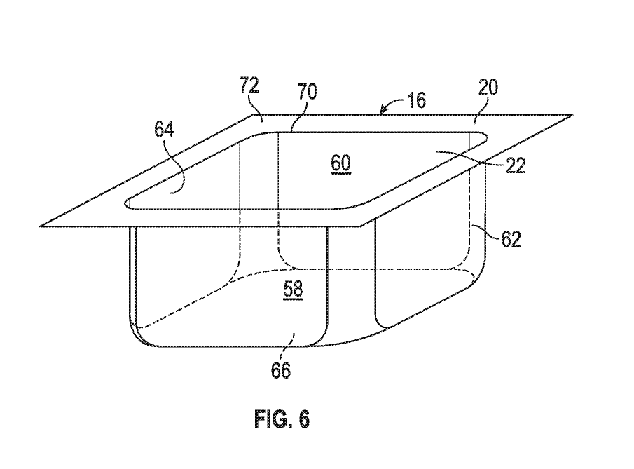

The dry depositor 12 may communicate with a thermoformer, which may take the form of a thermoforming packaging machine, generally designated 14, and a mold tray 16. The communication may be by way of a conveyor, shown schematically at 18, or other means, including conveying the output of the dry depositor 12 manually into the mold tray 16. The mold tray 16 may take the form of one or an array of individual molds 20, shown in FIGS. 2 and 6 for receiving the pieces of uncooked protein with the bonding enzyme preparation applied thereto from the dry depositor 12. Each of the molds 20 may be rectangular in shape and include a cavity 22 shaped to receive a pair of pieces of protein 24, 26, each of which may take the form of a skinless, boneless, whole-muscle, intact chicken breast 28, 30. In other embodiments, the pieces of protein 24, 26 may take the form of whole-muscle, intact, pieces of beef, pork, veal, and poultry, the latter including duck and turkey, as well as other pieces of chicken. The tray 16 may be integrated into the thermoforming packaging machine 14 and convey the contents, such as the chicken breasts 28, 30, to a thermoforming packaging component 32.

The thermoforming packaging component 32 may enclose the contents of the molds 20, namely the chicken breasts 28, 30, between sheets of plastic and evacuate the space between the sheets, sealing them together to form a vacuum-sealed package. Alternately, the pieces 28, 30 may be placed in plastic bags or pouches, which are then evacuated and vacuum sealed. In either embodiment, the vacuum-forming process urges the two pieces of protein 24, 26 together and conforms them to the shape of the interiors 22 of the molds 20 to form protein loaves from the pieces of protein 24, 26. An example of such a thermoforming machine is a Multivac R 530, manufactured by Multivac, Inc.

After the chicken pieces 28, 30 are sealed by the packaging component 32 of the thermoforming packaging machine 14, the trays of sealed protein pieces 24, 26, such as chicken breasts 28, 30, may be conveyed to a holding area 34, which may take the form of a table, rack, or cooled or refrigerated enclosure, by way of a conveyor 36, or optionally, manually. At the holding area 34, the trays of sealed protein pieces 24, 26 are held to allow sufficient cross-linking caused by the enzyme preparation to bind or fuse the breasts 28, 30 together. After the binding has been completed, the protein pieces 24, 26, which may take the form of chicken breasts 28, 30, fuse into unitary loaves 38, as shown in FIG. 3, which is sealed within the package 33.

In an embodiment in which the protein pieces 24, 26 are chicken breasts 28, 30, the resultant product is in the form of a chicken loaf 38. The sealed packages 33 of chicken loaves 38 may then be conveyed by a conveyor 40, or alternately conveyed manually, to a hot water cooker, which in embodiments may take the form of a sous vide cooker 42, where they are cooked thoroughly. An example of such a sous vide cooker 42 is the Armor Inox Thermix system, manufactured by Armor Inox of Mauron, France.

The system 10 may further include a freezer 44 that receives the cooked loaves 38 from the sous vide cooker 42 by way of a conveyor 46, or alternately by a conveyance such as a truck (not shown), or manually. The loaves 38, which are cooked and sealed within the packages 33 (FIG. 4), may be retained in the freezer 44 indefinitely. The system 10 also may include a delivery vehicle 46 that may be used to convey the frozen loaves 38 contained in packages 33 to an ultimate user, which may be a grocery store for sale to consumers, restaurant, or institutional food provider.

As shown in FIG. 1, in an optional embodiment, the system 10 may include a vacuum tumbler 48 that may receive fresh skinless, boneless whole-muscle, intact chicken, poultry, or other protein from a source, such as a hopper 50. The vacuum tumbler 48 may be of the type that tumbles the chicken breasts 28, 30, or protein pieces 24, 26 with salt and flavorings under a vacuum. Also optionally, the system 10 may include an infrared searing tunnel 52 that may receive the tumbled breasts 28, 30 or protein pieces 24, 26 from the vacuum tumbler 48 by way of a conveyor 54, or optionally manually.

With this embodiment, the infrared searing tunnel 52 may be adapted to sear the protein pieces 24, 26, which may take the form of chicken breasts 28, 30, on only one side. The searing may be with infrared light to provide a desirable appearance, and which may include “grill marks,” and which may sear one or both breasts 28, 30. The other side, which is to be the connecting or adjoining surface, is not seared because it might impair the bond to be formed. The infrared searing tunnel 52 may convey the seared protein pieces 24, 26 such as chicken breasts 28, 30, by way of a conveyor 56, or optionally manually, to the dry depositor 12. If the infrared searing tunnel 52 and/or vacuum tumbler 48 are not employed, the protein pieces 24, 26 may be deposited directly into the dry depositor by way of the hopper 50.

As shown in FIG. 6, a typical mold 20 of mold tray 16 (see also FIG. 2) may include a cavity 22 and may be made of plastic or metal, including stainless steel or other non-corrosive metals. The mold 20 may be used singly as shown in FIG. 6, or may be part of a tray 16 such as that shown in FIG. 2 and shown schematically in FIG. 1. Each mold cavity 20 may include opposing, generally parallel side walls 58, 60, and opposing, generally parallel end walls 62, 64. The mold 20 also may include a bottom wall 66, which is generally perpendicular to the side walls 58, 60 and end walls 62, 64. The side walls 58, 60, end walls 62, 64, and bottom wall 66 meet at rounded and/or angled corners.

The side walls 58, 60 and end walls 62, 64 meet to form an open top 70, which may be surrounded by a peripheral flange 72. The flange 72 may extend above, and approximately at right angles to, the side walls 58, 60 and end walls 62, 64. The flange 72 may be shaped to receive a top sheet of plastic or other sealant material 74 (see FIG. 3) and a bottom sheet 76, both of which may be applied by the thermoforming packaging component 32 of the thermoforming machine 14 (FIG. 1). The bottom sheet 76 is applied to the mold 20 beneath the pieces of protein 24, 26 by the thermoforming component 32 along the walls 62, 64 and bottom wall 58. The top sheet 74 may be applied along the peripheral flange 72 above the protein pieces 24, 26, as shown in FIG. 3. Alternately, the packaging 33 may take the form of a bag or pouch having all sides but one pre-sealed, in which case the protein pieces 24, 26 may be placed within the pouch 33 automatically or manually and the pouch containing the protein pieces placed within the mold 20 by the thermoforming component 32.

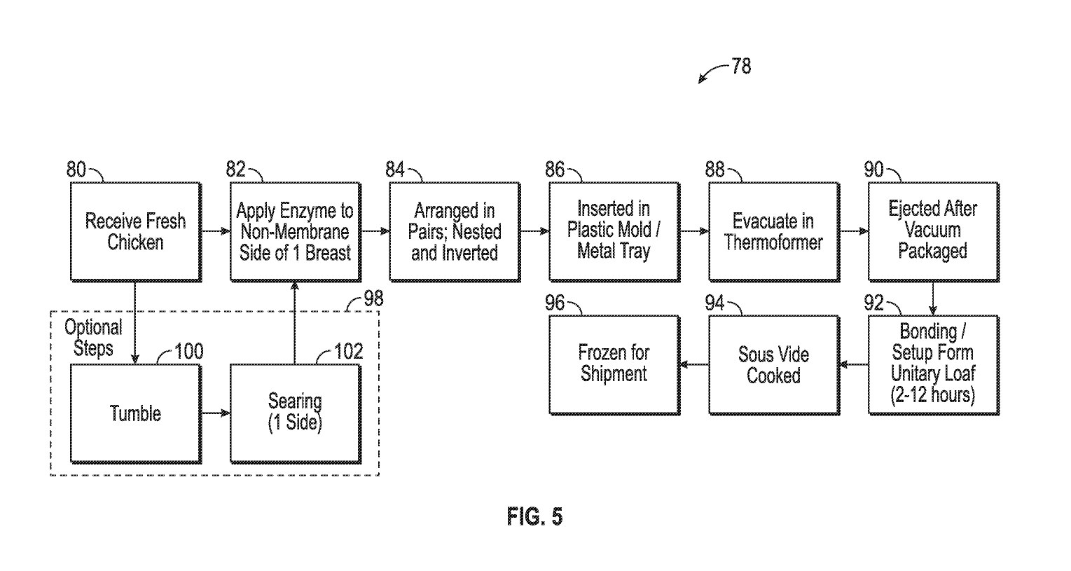

The method, generally designated 78, for making a protein loaf 38 (FIG. 4) is shown in FIG. 5. The method 78 begins with receiving fresh pieces of protein 24, 26, which may take the form of skinless, boneless, whole-muscle, intact or whole chicken breasts 28, 30, is received in the hopper 50, as indicated in block 80. At least a portion of each of the two pieces of protein 24, 26 is coated with a bonding enzyme preparation, in an embodiment utilizing the dry depositor 12, as indicated in block 82. Optionally, the enzyme may be applied manually. In an embodiment, only one side of the chicken breasts 28, 30 is coated on the non-membrane side, and the coating may be applied only to one breast 28, or to both breasts 28, 30.

As indicated in block 84, the protein pieces 24, 26 are arranged in molds 20, which may be in the form of trays 16, such that the coated portions of the two pieces of protein 24, 26 contact each other, or alternately, the coated portion of one piece 24, 28 touches the other piece 26, 30. As indicated in block 86, the protein pieces 24, 26 then are inserted in the molds 20, which may be plastic or a metal. In embodiments, the molds 20 may be in the form of a tray 16. As indicated in block 88, the molds 20 or tray 16 of molds next may be placed in a thermoforming packaging machine 14 which places the protein pieces between upper sheet 74 and bottom sheet 76 (or in a pouch) and the air is evacuated from around the protein pieces 24, 26. The vacuum also forces the pieces of protein 24, 26, which may be chicken breasts 28, 30, into the shape of the interior 22 of the mold 20, or generally in the shape of the interior 22 of the mold 20. The thermoforming packaging component 32 seals the protein pieces 24, 26 between the sheets 74, 76 to form the package 33, or a pouch that is sealed at an open end in which the pieces have been inserted.

As indicated in block 90, after the sealing process is then completed by the thermoforming packaging machine 14, the sealed protein pieces 24, 26 are ejected from the machine and, in an embodiment, conveyed by conveyor 36, or transported manually to the holding area 34. The sealed protein pieces 24, 26 may be held in the holding area 34 a time interval sufficient to permit the cross-linking, which is effected by the enzyme preparation applied to the piece 24 or pieces 24, 26, to cause the protein pieces to bond or fuse together to form a unitary loaf 38, as indicated at block 92. This bonding period may take anywhere from two to twelve hours. As indicated in block 94, the loaf 38 is then sous vide cooked in the cooker 42, having been conveyed from the holding area 34 by conveyor 40, or alternately manually transported.

As indicated in block 96, after sous vide cooking, the sealed loaf 38 may be conveyed by way of conveyor 46, or alternately manually conveyed, to a freezer 44 and frozen for shipment.

Also as indicated in FIG. 5, in broken line block 98, optional steps of tumbling the fresh protein pieces 24, 26 (which may be in the form of chicken breasts 28, 30) prior to applying the enzyme in block 82 may be performed, as indicated in block 100, by the vacuum tumbler 48 and/or searing the protein pieces 24, 26 on one side, by the infrared searing tunnel 52, as indicated in block 102.

As shown in FIG. 2, in an embodiment in which the protein pieces 24, 26 take the form of skinless, boneless, whole-muscle, intact chicken breasts 28, 30, the breasts may be nested within the mold 20 wherein the chicken breasts are inverted relative to each other. The chicken breasts 28, 30 each have a relatively enlarged end 104, 106 and a relatively tapered end 108, 110. As shown in FIG. 2, by inverting the chicken breasts 28, 30 relative to each other, the enlarged end 104 of chicken breast 28 is placed adjacent the tapered end 110 of breast 30, and conversely, the enlarged end 106 of breast 30 is adjacent the tapered end 108 of the chicken breast 28. This provides breast 28 with a bonding surface 112 along the length of the breast from the enlarged end 104 to the tapered end 108 that is adjacent a facing bonding surface 114 of breast 30, which likewise may along the length of the breast from the enlarged end 106 to the tapered end 110. In an embodiment, the bonding surfaces 112, 114 are the non-membrane sides of the breasts 28, 30.

The bonding enzyme preparation may be applied manually or by dry depositor 12 to one or both bonding surfaces 112, 114, and partially or entirely along the length of the bonding surface or surfaces. When the breasts 28, 30 are sealed within the package 33 by the thermoforming packaging machine 14, the surfaces 112, 114 contact each other along their lengths, and in embodiments along the entire lengths of the breasts 28, 30, as indicated in FIG. 3. In the vacuum forming process, the breasts 28, 30 (or protein pieces 24, 26) are urged together and held together along the bonding surfaces 112, 114. The breasts 28, 30 remain held together along bonding surfaces 112, 114 by the package 33 after the thermoforming process is completed. When the bonding process is completed, the interface between bonding surfaces 112, 114 is fused, resulting in the unitary loaf 38 shown in FIGS. 3 and 4.

The unitary loaf 38 may be prepared for eating by first removing the loaf 38 from the package 33, then slicing the product width-wise to form uniform slices. Alternately, the loaf 38 may be diced to form a topping or ingredient of an entrée, such as a salad. The loaf 38 will be cooked through by the sous vide cooker 42 (FIG. 1) and may be easily prepared for consumption or incorporation into a dish or serving. The end user need only heat the loaf 38 since it has already been cooked.

While the methods, systems and products disclosed herein constitute preferred embodiments of the method and system for making a protein loaf, and protein loaf product, it is to be understood that the invention is not limited to these precise methods, systems and products, and that changes may be made therein without departing from the scope of the invention.

1. A method for making a poultry loaf, the method comprising:
coating at least a portion of at least one of two pieces of poultry with a bonding enzyme preparation along a bonding surface of the at least one of two pieces of poultry;
nesting the two pieces of poultry in a mold and orienting the two pieces of poultry such the coated bonding surface of the at least one of the two pieces of poultry contacts a bonding surface of the other of the two pieces of poultry;
evacuating and sealing the two pieces of poultry in a package such that the two pieces of poultry are urged together along the bonding surfaces thereof and conform to the mold to form a loaf shape; and
holding the pieces of poultry in the sealed package a time interval sufficient to allow the bonding enzyme preparation to cause cross-linking to occur between the bonding surfaces to form a unitary poultry loaf from the two pieces of poultry.

2. The method of claim 1, further comprising sous vide cooking the poultry loaf while in the package.

3. The method of claim 2, further comprising freezing the sous vide cooked poultry loaf while in the package.

4. The method of claim 1, further comprising tumbling the two pieces of poultry under a vacuum prior to coating.

5. The method of claim 4, wherein tumbling includes tumbling the two pieces of poultry with salt and flavorings.

6. The method of claim 1, further comprising the initial step of searing at least one of the two pieces of poultry.

7. The method of claim 6, wherein the searing is performed on only one side of the at least one of the two pieces of poultry.

8. The method of claim 6, wherein the searing includes producing grill marks on the at least one of the two pieces of poultry.

9. The method of claim 1, wherein the two pieces of poultry are poultry breasts.

10. The method of claim 9, wherein the poultry breasts are boneless breasts.

11. The method of claim 9, wherein arranging the two pieces of poultry includes inverting the poultry breasts relative to each other.

12. The method of claim 11, wherein evacuating and sealing the package includes evacuating and sealing the package such that the inverted poultry breasts conform to a shape of the mold.

13. The method of claim 12, wherein the mold is part of a tray.

14. The method of claim 12, wherein evacuating and sealing the package includes placing the inverted poultry breasts in a package and evacuating and vacuum sealing the package in a thermoforming packaging machine.

15. The method of claim 1, wherein the poultry is selected from chicken, turkey, and duck.

16. A poultry loaf made by the process of claim 1.

17.-28. (canceled)

29. The method of claim 1, wherein holding the pieces of poultry in the sealed package includes conveying the sealed pieces of poultry in the sealed package to a cooled or refrigerated holding area, and holding the pieces of poultry in the sealed package to allow sufficient cross-linking caused by the enzyme preparation to bind or fuse the pieces of poultry together to form unitary loaves.

30. The method of claim 1, wherein coating at least a portion of at least one of two pieces of poultry includes coating at least a portion of at least one of two pieces of a skinless, boneless, whole-muscle, intact chicken breast.

31. The method of claim 1, wherein evacuating and sealing the two pieces of poultry in a package includes enclosing the two pieces of poultry between sheets of plastic and evacuating a space between the sheets, and sealing the sheets together to form a vacuum-sealed package.

32. The method of claim 31, wherein evacuating and sealing the two pieces of poultry in a package includes forcing the pieces of poultry into the shape of an interior of a mold.
